(19) United States
(12) Patent Application Publication
(10) Pub. No.: US 2007/0008726 A1
(43) Pub. Date: Jan. 11, 2007

(54) Lighting apparatus with proximity sensor

(76) Inventor: Richard D. Brown, East Lothian (GB)

Correspondence Address: NIXON & VANDERHYE, PC, 901 NORTH GLEBE ROAD, 11TH FLOOR, ARLINGTON, VA, 22203, US

(21) Appl. No.: 10/570,167

(22) PCT Filed: Aug. 31, 2004
(86) PCT No.: PCT/IB04/02806

§ 371 Date: Mar. 1, 2006

(30) Foreign Application Priority Data
Sep. 2, 2003 (AU) 2003904758

(51) Int. Cl. F21V 9/00

(52) U.S. Cl. 362/276; 362/231; 362/802

(57) ABSTRACT

There is disclosed a lighting apparatus comprising a light source (502) capable of outputting light in a plurality of different colours, a proximity sensor (501) for generating a proximity signal indicative of the proximity of at least part of a person to the proximity sensor, and a controller for controlling the light source on the basis of said proximity signal to output at least one of a plurality of colours.

### The present application claims priority of Australian provisional patent application 2003904758, the disclosure of which is incorporated herein by reference.

### FIELD OF THE INVENTION

The present invention relates to a lighting apparatus capable of outputting light in at least one of a plurality of colours on the basis of a proximity signal.

### BACKGROUND OF THE INVENTION

Coloured lights have been used as one method of providing ambient or “mood” lighting. These lighting devices have a fixed colour and are non-interactive. It would be desirable to provide an alternative lighting apparatus with which a user can interact.

### SUMMARY OF THE INVENTION

The invention provides lighting apparatus comprising:
a light source capable of outputting light in a plurality of different colours;
a proximity sensor for generating a proximity signal indicative of the proximity of at least part of a person to the proximity sensor; and
a controller for controlling the light source on the basis of said proximity signal to output at least one of a plurality of colours.

The intensity of the colours may also be controlled.

Preferably the proximity sensor is co-located with the light source.

In one embodiment, said controller is configured to control the light sources to output a sequence of two or more of said plurality of colours on the basis of said proximity signal.

In one embodiment, said sequence is based on said proximity signal over a sensing period.

Preferably the end of the sensing period is determined by the withdrawal of said part of the person from the proximity of the proximity sensor.

The colour sequence is typically output over a display period which is much longer than the sensing period. For example a sequence derived from a sensing period of 30 seconds may be replayed over the course of 30 minutes or five hours. Another example is a sequence derived from a sensing period of 20 minutes replayed over four weeks.

The sequence may be replayed indefinitely until a new sequence is input.

Preferably, the controller has a memory which stores the sequence of changing values of the proximity signal for the sensing period.

Preferably, the light source is a plurality of LEDs of differing colours.

Preferably, the light source is enclosed within a translucent diffuser.

### BRIEF DESCRIPTION OF THE DRAWINGS

A preferred embodiment of the invention will now be described in relation to the accompanying drawings in which:

FIG. 1 is a schematic diagram of the preferred embodiment of the invention;

FIG. 2 is a flow chart which shows how the controller operates; and

FIG. 3 is a graph of the mapping function for the spectrum produced by the LEDs.

FIG. 4 is an exemplary circuit diagram for the proximity sensor circuit.

FIG. 5a is an illustration of one possible shape for the diffusor.

FIG. 5b is an illustration of a possible construction of the apparatus.

FIG. 5c is an illustration of one possible mounting for the apparatus.

FIG. 6a is another example of a possible diffusor shape.

FIG. 6b is an example of a construction of the apparatus when the diffusor of 6a is used.

### DESCRIPTION OF PREFERRED EMBODIMENT

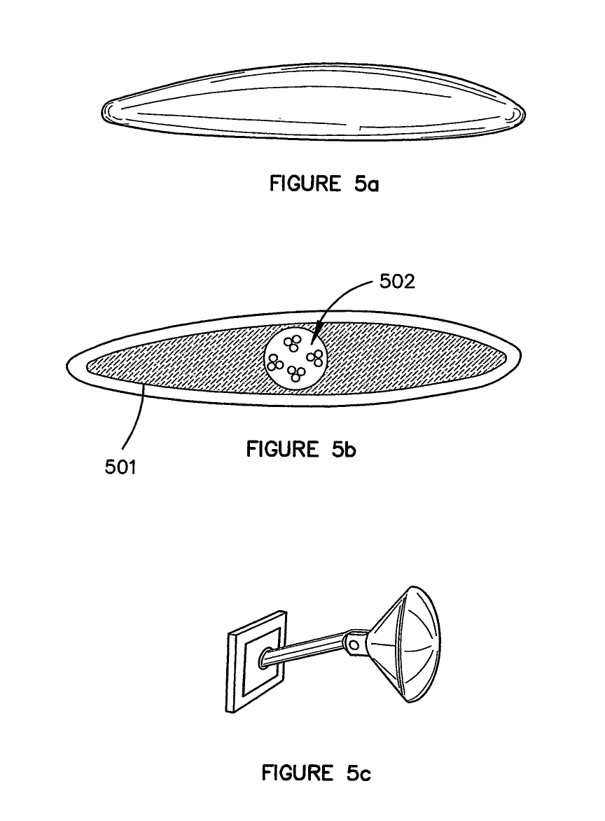

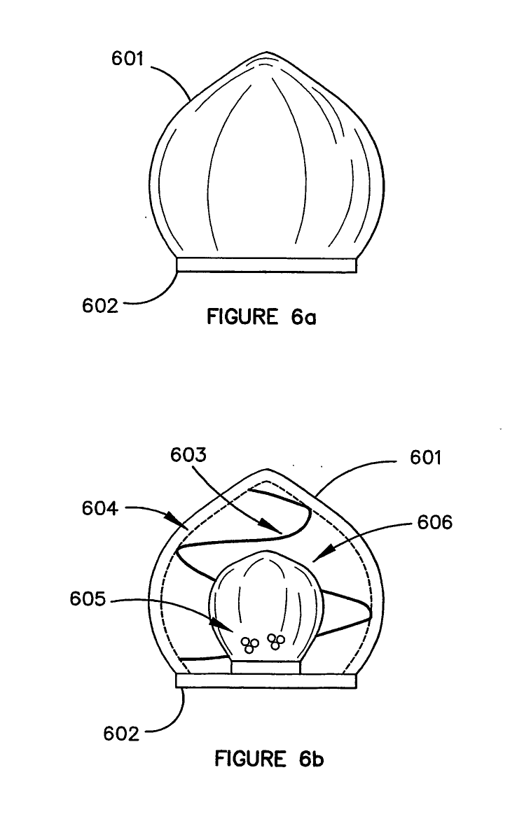

The preferred embodiment provides a lighting apparatus where a multi-coloured light source, proximity sensor and controller are incorporated within a lamp which can be connected to a standard power outlet. Examples of possible constructions of the apparatus are shown in FIGS. 5 and 6.

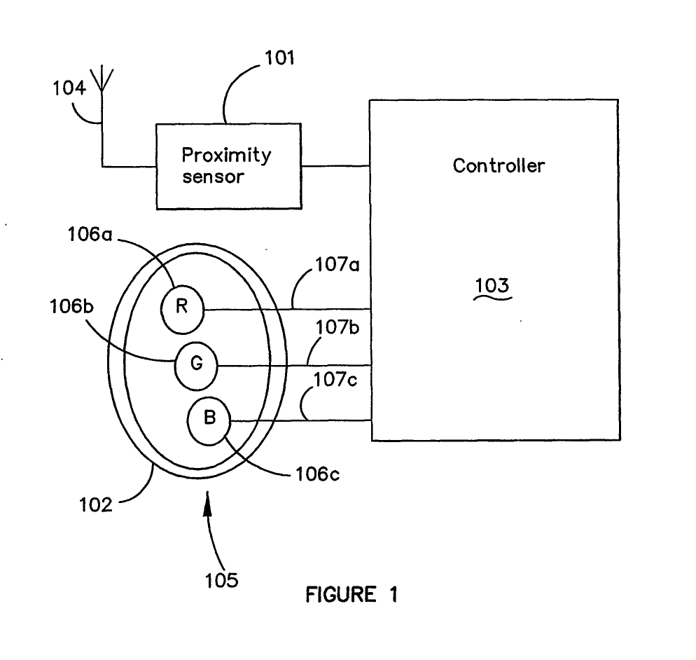

Referring to the drawings, FIG. 1 is a schematic diagram of the preferred embodiment of the lighting apparatus. The light source 105 of the preferred embodiment of the present invention has three high intensity light emitting diodes (LEDs) 106 enclosed in a diffuser 102 made of translucent white acrylic plastic. Persons skilled in the art will appreciate that the diffuser could be made of glass or some other suitable substance and made in any desired shape. The LEDs are Red 106a, Green 106b, and Blue 106c, and can be collectively controlled to output a plurality of different colours across the colour spectrum.

The intensities of the colours may also be controlled.

The proximity sensor 101 measures the proximity of a part of the body such as the user's hand to the antenna 104 and produces a proximity signal. The controller reads this signal and controls the LEDs on the basis of the proximity signal to output at least one colour as will be discussed further below. While shown as separate in FIG. 1, it is preferred that the antenna is located within the diffuser 102. An example of this in a possible construction of the apparatus is shown in FIG. 6b.

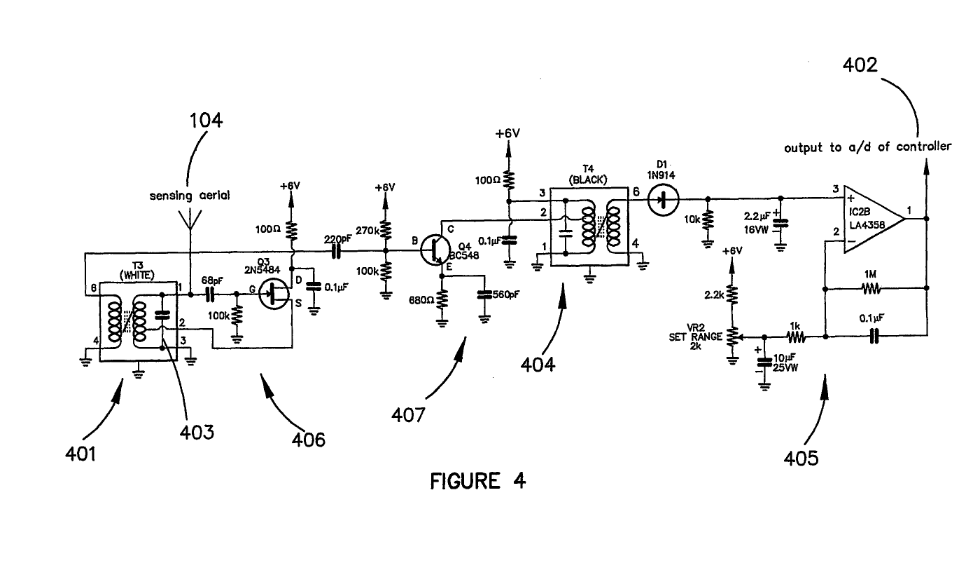

In the preferred embodiment the proximity sensor 101 is a capacitive sensor which uses the same principle as a theremin. A capacitive proximity sensor uses the capacitive effect of the human body on electric fields. The antenna and the user's hand serve as plates of a variable capacitor, with the hand grounded by the body and air being the dielectric. As the hand is brought closer to the antenna the capacitance increases. Referring to FIG. 4 the variable capacitance is included in a circuit in parallel with capacitor 403. Capacitor 403 and the variable capacitance form part of the first oscillator section 406 and are coupled inductively by first transformer 401 which combines with a second oscillator section 407 to produce a frequency signal. Second transformer 404 converts the frequency signal to a voltage and amplifying section 405 converts this voltage to an output voltage (“the proximity signal”). In the exemplary circuit diagram of FIG. 4 the proximity signal is output 402 as a changing voltage, indicative of the proximity of a user's hand to the antenna 104.

Analogue to digital converter within controller 103 converts the analogue signal from the proximity sensor. In the exemplary embodiment, the controller is an AVR 8-bit microprocessor with in-built analogue to digital conversion. Those skilled in the art will appreciate that other microprocessors could be used, or a separate microprocessor and analogue to digital converter could be used.

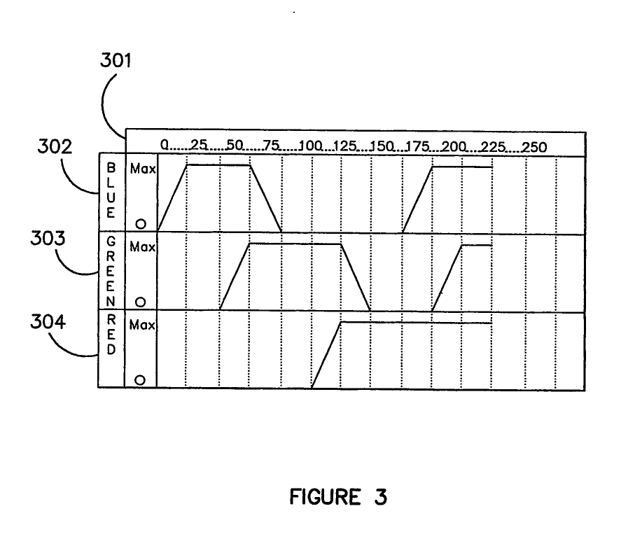

Thus, for the exemplary embodiment, an 8-bit proximity signal produces values in the range of 0-255 which is mapped to a colour spectrum from off through blue, green, yellow, orange, red, purple, white, including shades in between each colour. It will be appreciated that the possible shades are limited only by the resolution of the input value. An exemplary, mapping function for the conversion of the proximity signal into light for an embodiment using a red, green, and blue light source is illustrated in FIG. 3. The value 0 corresponds to no proximity signal (i.e. below a threshold) and 255 corresponds to closest proximity.

Referring to FIG. 3, the range of outputs 301 is shown along the top of the diagram and the amount of blue 302, green 303, and red 304 light output for different proximity signals is shown as varying from zero to maximum output to produce a range of colours.

In the exemplary embodiment, the LEDs are driven using a form of pulse code modulation to produce varying levels of intensity from each LED. This is achieved by a timed loop of code that determines how many times in each cycle the LED is pulsed on and how many times it is pulsed off. The speed of the pulsing is such that the eye only perceives an intensity of light rather than seeing the on/off pulses. For example in a cycle of 12 pulses, 1 on and 11 off produces a dim light, 6 on 6 off is half intensity, and 12 on and 0 off is full intensity.

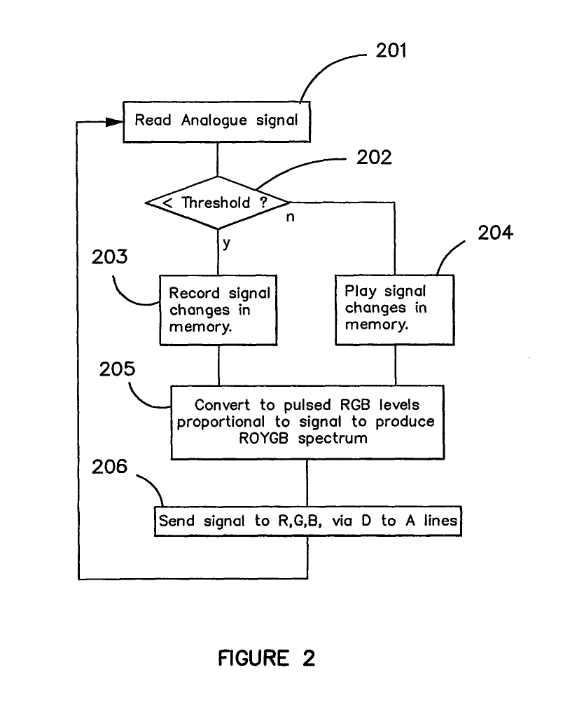

While, the light of the preferred embodiment can be used to output a single colour, it will usually be used to display a sequence of colours. Accordingly, the lighting apparatus has recording and playback modes. The recording and playback functionality is illustrated in FIG. 2. The controller continually monitors the proximity signal at step 201 and determines if is above a threshold at step 202. If the signal is above a threshold (i.e. a person is in proximity to the sensor) the controller enters record mode. During recording mode the controller simultaneously records input signal sequence 503 while outputting colours corresponding to the proximity signal. The recording mode lasts while at least part of the person is within the sensing proximity of the sensor. The controller is configured to store the signal for a predetermined sensing period of time prior to the person's hand being removed. In the preferred embodiment, the controller is configured to discard that part of the signal which corresponds to the person removing their hand. Persons are instructed to remove their hand rapidly when they have finished recording a sequence. The controller can then determine when the user removed their hand from the rapid change in proximity signal to zero. When no part of the person is within the sensing proximity of the sensor the device plays the recorded signal sequence from memory 502 and this is converted at step 205 to RGB signals and the signal is sent to the light source at step 206. The rate at which the sequence is played from memory is controlled by a time function in order to replay the sequence over a longer time period than the sensing period. For example a sequence derived from a sensing period of 30 seconds may be replayed over the course of 30 minutes or five hours. The time function may also replay the signal over a varying time period, for example gradually slowing down and speeding up the sequence back to the original recorded speed over the period of an hour.

Thus, the preferred embodiment of the current invention provides an interactive lighting device responsive to the user's proximity and movement without requiring physical intervention and touch and which also has the ability to be programmed by the user to replay desired lighting sequences over a given time period.

In alternative embodiments, the controller may also be programmed to include additional conversion and memory routines to provide additional lighting effects (for example ripples and echoes). Further, the controller may include additional memory to record more than one sequence for playback and means for selecting between recorded or pre-stored sequences. Further, recorded sequences could be layered to create additional lighting effects.

In another embodiment recorded sequences could be date stamped so that the device replays sequences recorded at particular times, with cycles that could be a week, a month or a year.

Another embodiment of the invention comprises synchronizing a sequence to a time period—e.g. specifying that a sequence of 20 seconds should be played back over one, two or three hours.

FIG. 5a illustrates a possible cigar shape for the diffusor. FIG. 5b illustrates a possible construction of the apparatus where the sensing aerial also acts as a light reflector 501 and the LED light source comprising one or more LED light emitters 502 is located in the middle of the light reflector. A possible method for mounting the apparatus using a wall mounting bracket and arm extending from the wall mounting bracket and allowing rotation of this embodiment of the apparatus is shown in FIG. 5c.

FIG. 6a illustrates a possible shape for a free standing version of the apparatus. In this example the diffusor 601 is mounted on a base 602 that houses the electronic circuitry. The sensor aerial is either as a wire coiling inside the diffusor 603 or alternatively a conductive coating on the inside of the diffusor which acts as the sensing aerial. The example in FIG. 6b shows the light source as Red Green Blue LED clusters 605 inside an internal diffusor 606.

Persons skilled in the art will appreciate that alternative proximity sensing technology can be used. For example, another embodiment of the invention may comprise an inductive proximity sensor and whereby the user can interact with the device using a metallic object such as a metal wand. In this case, the proximity of the person is inferred from the proximity of the wand. Alternative embodiments may use optical sensing such as infra red, or a camera responding to movement with specific gestures used to control the light.

Persons skilled in the art will also appreciate that alternatively using a different circuit the proximity signal could be output as a changing frequency.

It will also be appreciated that while it is preferred that the proximity sensor is located with the light, the sensor could be incorporated as part of a light switch or in some other appropriate location—for example if the light is to be placed at a position that would be out of the reach of a user. It will also be appreciated that numerous techniques can be used to define the sensing period. For example, it may start when the threshold is exceeded or be triggered by a switch or the like.

It will also be apparent to persons skilled in the art that other color combination techniques such as CYMK could be used to output the plurality of colours. Further, any light source that can produce a spectrum of colours from one input signal may be used.

It will also be apparent to persons skilled in the art that other resolutions for analogue to digital conversion may be used and the mapping of the proximity signal to the output colours varied accordingly. Further, algorithms other than pulse code modulation for conversion of the proximity signal sequence for driving the light source may be used.

Persons skilled in the art will appreciate that other power sources may be used—for example, the light may be battery powered or solar powered.

These and other variations will be apparent to persons skilled in the art. These modifications should be considered as falling within the scope of the invention disclosed herein.

1. Lighting apparatus comprising:
a light source capable of outputting light in a plurality of different colours;
a proximity sensor for generating a proximity signal indicative of the proximity of at least part of a person to the proximity sensor; and
a controller for controlling the light source on the basis of said proximity signal to output at least one of a plurality of colours.

2. Lighting apparatus as claimed in claim 1, wherein the proximity sensor is co-located with the light source.

3. Lighting apparatus as claimed in claim 1, wherein said controller is configured to control the light sources to output a sequence of two or more of said plurality of colours on the basis of said proximity signal.

4. Lighting apparatus as claimed in claim 3, wherein said sequence is based on said proximity signal over a sensing period.

5. Lighting apparatus as claimed in claim 4, wherein the end of the sensing period is determined by the withdrawal of said part of the person from the proximity of the proximity sensor.

6. Lighting apparatus as claimed in claim 3, wherein said sensing period is a period of time during which said proximity signal is greater than a predetermined threshold.

7. Lighting apparatus as claimed in claim 6, wherein said sensing period is limited to a maximum sensing period the end of which is determined by the withdrawal of said part of the person.

8. Lighting apparatus as claimed in claim 3, wherein the sequence is output over a display period which is longer than the sensing period.

9. Lighting apparatus as claimed in claim 5, wherein the sequence is replayed indefinitely until a new sequence is input.

10. Lighting apparatus as claimed in claim 1, wherein the controller has a memory that stores the sequence of changing values of the proximity signal for the sensing period.

11. Lighting apparatus as claimed in claim 1, wherein the light source comprises a plurality of LEDs of all colours of a colour separation.

12. Lighting apparatus as claimed in claim 11, wherein said LEDs are red, green and blue.

13. Lighting apparatus as claimed in claim 1, wherein the light source is enclosed within a translucent diffuser.

14. Lighting apparatus as claimed in claim 1 that constitutes a light.
